(19) United States
(12) Patent Application Publication
(10) Pub. No.: US 2018/0165765 A1
(43) Pub. Date: Jun. 14, 2018

(54) METHOD AND SYSTEM FOR ORGANIZING A TEAM OF INDIVIDUAL SERVICE PROVIDERS THROUGH A CENTRALIZED PROVIDER

(71) Applicant: James C. Eastman, (US)

(72) Inventor: James C. Eastman, (US)

(21) Appl. No.: 15/101,641

(22) PCT Filed: Apr. 8, 2015
(86) PCT No.: PCT/US15/24900

§ 371 Date: Jun. 3, 2016

(30) Foreign Application Priority Data
Apr. 8, 2014 (US) 14247610

(51) Int. Cl. G06Q 40/06; G06F 17/30

(52) U.S. Cl. CPC G06Q 40/06; G06F 17/30873

(57) ABSTRACT

A method and system wherein a central provider that acts as a marketing and referral company by enrolling professional advisors and service/product providers as members, thereby enabling the central provider to control the quality of advice, services and product provided to clients of the central provider. The central provider then provides a central portal, such as an office and/or website members can use to meet with the client in using a team approach.

### FIELD OF THE INVENTION

This invention relates to the field of wealth management and more particularly a method and system for teaming individual service providers together to provide a collaborative approach to financial planning for a client through a central provider.

### BACKGROUND OF THE INVENTION

A family office or single family office is a private company that manages investments and trusts for a single family. The company's financial capital is the family's own wealth, often accumulated over many family generations. Traditional family offices provide personal services such as managing household staff and making travel arrangements. Other services typically handled by the traditional family office include property management, day-to-day accounting and payroll activities, and management of legal affairs. Family offices often provide family management services, which includes family governance, financial and investment education, philanthropy coordination, and succession planning.

The major obstacle for widespread use of family offices has been the high cost. A single family office can cost $1 to $1.5 million per year to operate, primarily due to overhead costs such as rent and payroll. Therefore, a family office is only affordable to families with investment assets in excess of $100 million.

Further, and perhaps most importantly, it is estimated that only about 8% of wealthy families are successful at maintaining wealth beyond the third generation. The story of “shirtsleeves to shirtsleeves in three generations” has been around a long time, and for a reason. While we all assume we are protecting our wealth with some planning, the use of trusts and other techniques, industry statistics prove otherwise. Although most families put trusts and entities in place to protect wealth from some risk, they do not put in place processes and procedures to guide future generations in the prudent management of wealth.

First principles reasoning certainly informs us on some important aspects of best practices in wealth management. These first principles may seem obvious, but it is also obvious that they are missing in today's wealth management business. The industry has quality individual service providers, but it is too fragmented, lacks co-ordination and integration, and is too expensive.

Now let's imagine the whole and complex economic ecosystem of financial products and services. We observe:
1. It is large and complex and consists of a large number firms in several separate disciplines, each with different areas of expertise. Large and small, highly and less highly regarded in their respective professions.
2. There is little evidence of meaningful collaboration across multiple disciplines. Would you build a house where the architect did not communicate with the builder, plumber or electrician? Certainly not. Neither should one build a wealth plan where the chief planner does not communicate with the CPA, attorney, investment manager or insurance agent.
3. Due to inefficiencies in the delivery of financial services and related products, the process is cumbersome and often overly expensive.
4. Quality and performance is difficult to determine for the ultimate consumer except after the fact. For example many times poor investment performance is only discovered after large losses . . . way too late for most investors.
5. For most families, advice is being offered by people who are in reality salespersons.

Therefore, the need exists for a method and system that redefine the wealth management business from a non-integrated, sales based system to a fully integrated, professional advisor based system and creates an organizational structure that both encourages and enables full integration and collaboration among the professions and business enterprises that are necessarily involved in wealth management.

The relevant prior art includes the following references:

| | | |
|---|---|---|
| Pat. No. | Inventor | Issue/Publication Date |

(U.S. Patent References)

| | | |
|---|---|---|
| 2002/0152099 | Carr, Jr. et al. | Oct. 17, 2002 |
| 2004/0128253 | Jim | Jul. 1, 2004 |
| 7,321,870 | Comiskey et al. | Jan. 22, 2008 |
| 2008/0103823 | Papa | May 1, 2008 |
| 7,848,984 | Robb | Dec. 7, 2010 |
| 8,195,555 | Robb | Jun. 5, 2012 |
| 2012/0209699 | Cochran et al. | Aug. 16, 2012 |

### SUMMARY OF THE INVENTION

The primary object of the present invention is to provide a method and system that redefine the wealth management business from a non-integrated, sales based system to a fully integrated, professional advisor based system.

An additional object of the present invention is to provide a method and system that creates an organizational structure that both encourages and enables full integration and collaboration among the professions and business enterprises that are necessarily involved in wealth management.

An additional object of the present invention is to provide a method and system that develops a wealth management process that simplifies the process for clients and provides efficiencies to make comprehensive wealth management more affordable.

An additional object of the present invention is to provide a method and system that establishes the corporate infrastructure to enable us to execute our plans, including the creation of a family office administration firm, a fee-only financial planning firm and solutions based money management firm.

An additional object of the present invention is to provide a method and system wherein clients are also members of a central provider, thereby providing said clients with a family office type model.

The present invention fulfills the above and other objects by providing a multi-family office or central provider that acts as a marketing and referral company by enrolling professional advisors and service/product providers as members, thereby enabling the central provider to control the quality of advice, services and product provided to clients of the central provider. The central provider then provides a central portal, such as an office and/or website members can use to meet with the client in using a team approach.

Currently, there are at least six businesses involved in professional wealth management, but they are not integrated into the process of wealth management.

The following three professions, referred to as advisory providers, generally work for a fee paid by the client and are held to a fiduciary standard of care:
Financial Planning/Investment Consulting
Tax & Accounting
Legal & Estate Planning

The three businesses providing financial products and services, referred to as service/product providers, generally create and distribute financial products through sales forces. They are generally held to a lower suitability standard of care. Trust companies are slightly different as they too create necessary products and services, but they are deemed fiduciaries.
Investment Brokerage
Insurance & Annuities
Trust Services

All of these professions and businesses are involved in wealth management individually and are generally autonomous of each other. The result is a system and process that is complex, confusing and costly.

The present method and system integrates advisory providers into a single team that provides combined services through a central provider for the benefit of the client. This assembled group works together as a cohesive team, providing advice, implementation and monitoring services to the client. The advisory providers formulates a wealth management plan and then selects financial service/product providers from the central provider's membership network of service/product providers and oversees implementation of the management plan. Finally, the advisory providers, or a member thereof, is responsible for ongoing monitoring of the management plan and reporting to the client. The advisor team then meets periodically with the client in order to determine if changes are necessary due to changes within the family and its unique goals and circumstances, changes in the tax laws, or other issues that may arise from time to time.

The central provider creates and maintains a membership based network of advisory providers that are matched with clients and service/product providers. Each member is proposed and vetted through a due diligence process by the central provider to assure high quality and reasonable prices.

This process is enabled by using “cloud storage” services for all important financial documents. This enables quick and easy communication of all important and relevant information between the client and any relevant member of the team of advisory providers as appropriate under the circumstances.

An additional benefit of the method and system of the present invention is that general and/or specific information regarding a client may be provided to a vendor and then used as a sales lead.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a block diagram illustrating the basic components of the method and system of the present invention;

FIG. 2 is a block diagram showing a central provider, advisory providers and service/product providers of the method and system of the present invention;

FIG. 3 is a flowchart showing the steps for a client retaining the central provider for wealth management services;

FIG. 4 is a flow chart showing the steps for an individual advisory provider applying to be a member of the central provider's network of service providers;

FIG. 5 is a block diagram showing the steps of a central provider matching an individual advisory provider to a client through the central portal;

FIG. 6 is a flow chart showing the steps for an individual service/product provider applying to be a member of the central provider's network of service/product; and

FIG. 7 is a flow chart showing the steps of transforming a client's personal and financial information into a sales lead.

### DESCRIPTION OF THE PREFERRED EMBODIMENTS

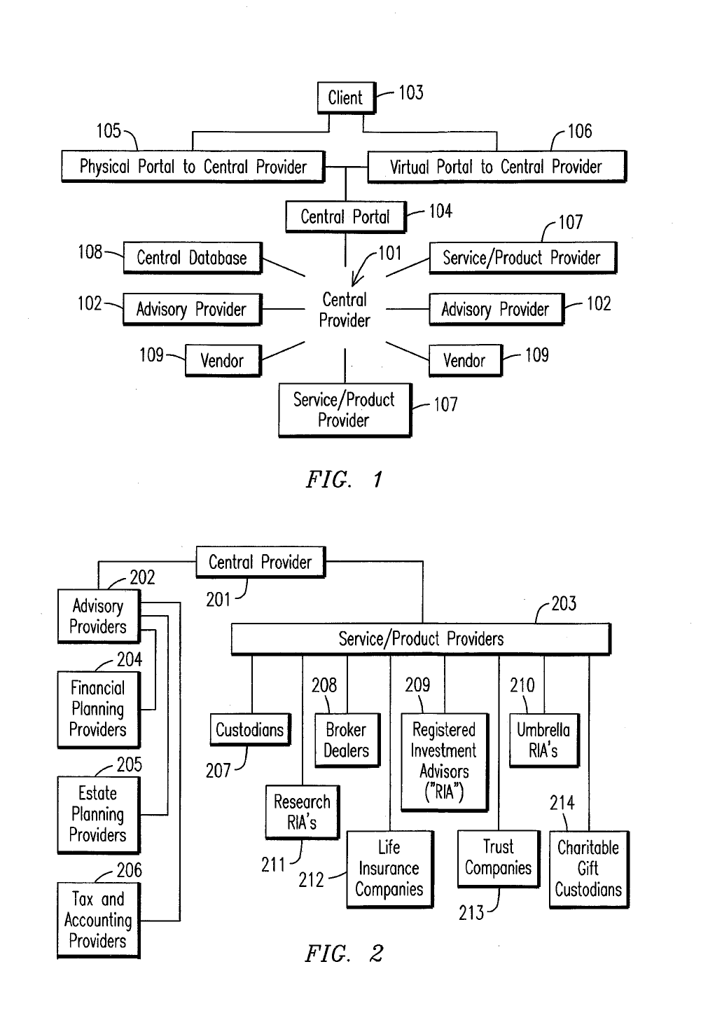

With reference to FIG. 1, a block diagram illustrating the basic components of the method and system of the present invention is illustrated. A central provider 101 provides a system for matching individual advisory providers 102 with a client 103 based on criteria determined by the client's economic status, income, asset level, age, geographic location and various other factors. Those individual service providers 102 are then assembled into a team to assist the client 103 with managing the client's estate and financial portfolio through the central provider 101. Services provided by the team of individual advisory providers 102 are done so through the central provider 101 through a central portal 104, such as a physical portal 105 and/or a virtual portal 106.

The physical portal 105 may be an actual physical office provided by the central provider 101 that the individual advisory providers 102 can use to meet with the client 103. Therefore, the entire team of advisory service providers 102 can be assembled in one location for a meeting with the client 103 as opposed to the client 103 being required to travel to separate offices. This also provides convenience to the client 103 by providing a single location to hold meetings. For example, whether the client 103 is meeting with an advisory provider 102, the meeting will always be at a single physical location. An additional advantage of the physical portal 105 is that the central provider 101 may have physical offices in multiple geographic locations. Therefore, if the client 103 is traveling or splits time between more than one home, a physical office will be available for the client 103 to meet with one or more of the advisory service providers either in person or by voice and/or video conference. By centralizing the services of the various advisory providers 102, a collaborative management of the client's portfolio is achieved, thereby ensuring that all advisory providers 102 are provided a full picture of the client's portfolio through the central provider 101. The advisory providers 102 are then able to formulate a wealth management plan and selects financial service/product providers 107 from the central provider's membership network of service/product providers 107 and oversee implementation of the management plan.

The virtual portal 106 is an online account which the client 103 may log into to gain access. The virtual portal 106 allows the client 103 and advisory service providers 102 working on the client's team to access a preferably cloud supported central database 107 where the client's information and important documents are stored. This further allows for collaboration between each individual advisory provider 102 by providing an additional means for each individual advisory provider 102 to monitor the status of the client's matters and to know what actions the other advisory providers 102 on the team are taking with regard to the client 103.

After information is gathered from the client 103 by the central provider 101 and the team of advisory providers 102, that information may be used to provide select vendors 109 with general information regarding the client 103 which the vendor 109 may then use as a sales lead. The central provider 101 may also compile that information to provide lists of multiple clients 103 based on geographic location, net worth, personal interests, hobbies and so forth that a vendor 109 may then use to marketing products to the clients 103, as further illustrated in FIG. 8.

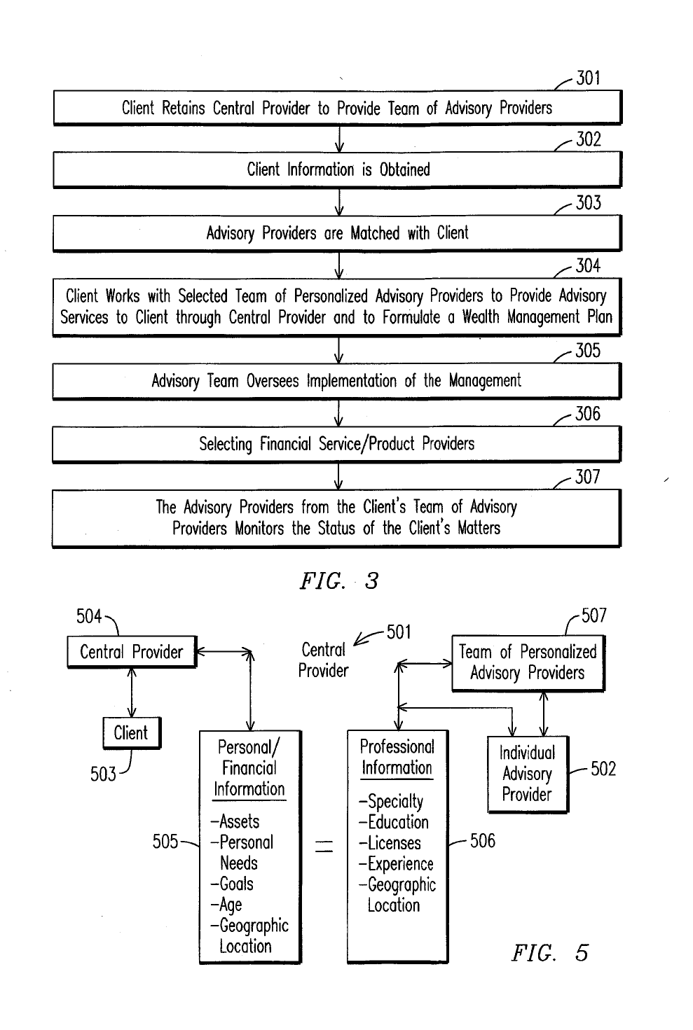

With reference to FIG. 2, a block diagram showing a central provider 201, advisory providers 202 and service/product providers 203 of the method and system of the present invention is illustrated. The membership based group of advisory providers 202 comprises financial planning providers 204, estate planning providers 205 and so forth. The membership based group of approved service/product providers 203 comprises custodians 207, broker dealers 208, registered investment advisors (“RIA”) 209, umbrella RIA 210, research RIA 211, life insurance companies 212, trust companies 213, charitable gift custodians 214 and so forth.

With reference to FIG. 3, a flowchart showing the steps for a client retaining the central provider for wealth management services is illustrated. First, the client retains the central provider to assemble and provide a team of advisory providers for the client to work with 301. When the client retains the central provider, the client is also enrolled as a member of the central provider. This process may also include an approval of the client by the central provider. As a member of the central provider, the client is provided access to benefits provided by the central provider, such as discounts on products and services (including products and service of third parties). In addition, the clients are provided with a predetermined level of control and governance over the central provider. Then, the central provider obtains personal and financial information from the client 302. Next, individual advisory providers are matched with the client 303, as illustrated in FIG. 5. Then, the client works with the team of advisory providers to formulate a wealth management plan for the client 304. Next, the advisory team oversees implementation of the management plan 305, which includes selecting financial service/product providers from the central provider's membership network of service/product providers to fulfill requirements of the management plan 306. Finally, one or more of the advisory providers from the client's team of advisory providers monitors the status of the client's matters and management plan 307.

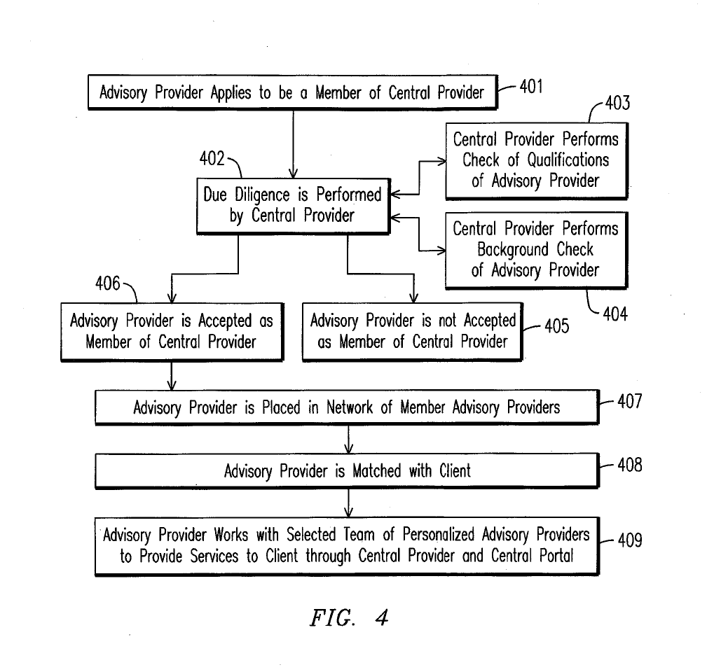

With reference to FIG. 4, a flow chart showing the steps for an individual advisory provider applying to be a member of the central provider's network of service providers is illustrated. First, the advisory provider applies to be a member of the central provider's network of advisory providers 401. Then, the central provider performs due diligence 402 on the qualifications of the advisory provider 403 and background of the advisory provider 404. If the advisory provider does not qualify to become a member of the central provider's network of advisory providers then the process ends 405. If the advisory provider qualifies to become a member of the central provider's network of advisory providers 406 then the advisory provider is placed in the central provider's network of approved advisory providers 407. Finally, if the individual advisory provider is matched with a client 408, as illustrated in FIG. 5, then the individual advisory provider is placed on a team of advisory providers to assist the client with a wealth management plan 409.

With reference to FIG. 5, a block diagram showing the steps of a central provider 501 matching an individual advisory provider 502 to a client 503 through the central portal 504 is illustrated. The central provider compares personal and financial information 505 collected from the client 503. The personal and financial information 505 may comprise amount and types of assets, personal needs, goals, age, geographic location, family information and so forth. An individual advisory provider 502 is matched with the client 503 by comparing the professional information 506 of the advisory provider 502 with the personal and financial information 505 of the client 503. If the advisory provider 502 is a match then the advisory provider is placed in a team of personalized advisory providers 507 to work with the client 503 through the central provider 501 and the central portal 504 to formulate, implement and monitor a wealth management plan for the client 503.

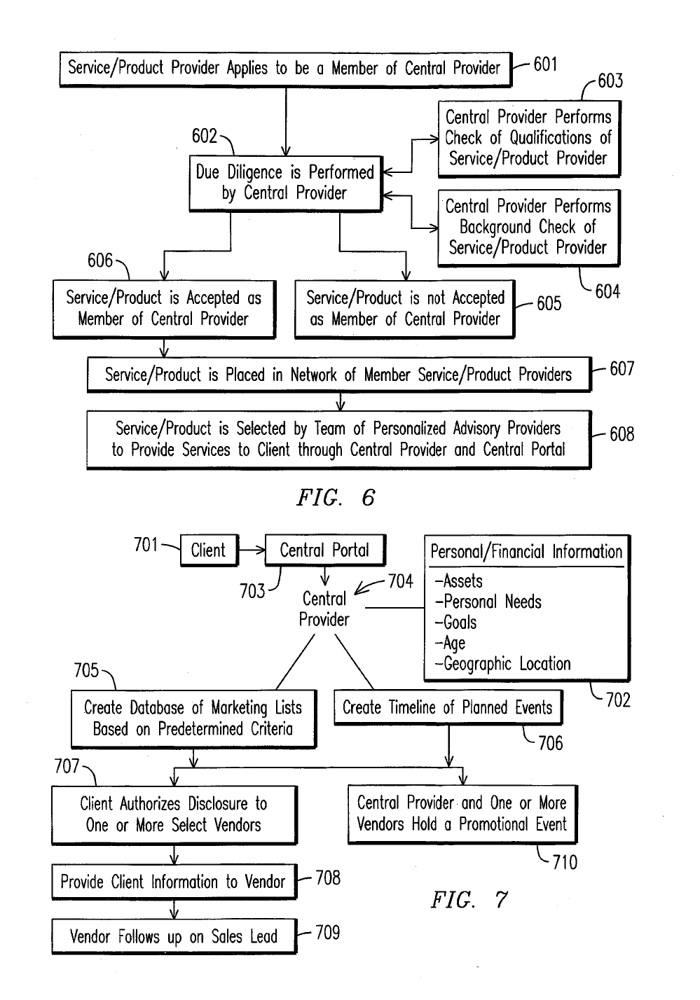

With reference to FIG. 6, a flow chart showing the steps for an individual service/product provider applying to be a member of the central provider's network of service/product providers is illustrated. First, the service/product provider applies to be a member of the central provider's network of service/product providers 601. Then, the central provider performs due diligence 602 on the qualifications of the service/product provider 603 and background of the service/product provider 604. If the service/product provider does not qualify to become a member of the central provider's network of service/product providers then the process ends 605. If the service/product provider qualifies to become a member of the central provider's network of service/product providers 606 then the service/product provider is placed in the central provider's network of approved advisory providers 607. Finally, the individual service/product provider may be selected by a team of personalized advisory providers to provide services to a client through the central provider and central portal 608.

With reference to FIG. 7, a flow chart showing the steps of transforming a client's personal and financial information 702 into a sales lead is illustrated. First, a client 701 provides personal and financial information 702 to a central provider 704 through a central portal 703. Then the personal and financial information 702 information may then be added to a marketing list 705 having predetermined criteria, such as age, geographic location, income level and so forth, and then provided to a vendor 708 who can follow up on the sales lead 709 after the client has provided authorization to the central provider for the information to be disclosed to one or more select vendors 707. Alternatively, the client's information may be used to create a timeline for the client 706 setting forth certain planned events and goals in the client's life. For example, the client may be planning for a vacation, the purchase of a vehicle, boat and/or house, planning a retirement date and so forth. That timeline of events and goals may then be used to create targeted sales leads to provide to vendors 708 after the client has provided authorization to the central provider for the information to be disclosed to one or more select vendors 707. Such sales leads may include a desired product, a desired price range and a desired time frame within which to purchase the product. The central provider may also use the client information to plan promotional events with one or more vendors that the client is invited to attend 710.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method of organizing a plurality of individual advisory providers from various professions into a team that provides services to a client through a central provider, said method comprising the steps of:
a. a client retaining a central provider to provide a team of advisory providers;
b. said client providing client's personal information to the central provider to be saved in a central database;
c. said central provider selecting a plurality of advisory providers from a group of member service providers to act as a team of advisory providers assigned to provide services to the client; and
d. said client receiving services from said team of service providers through a central portal provided by the central provider.

2. The method of claim 1 further comprising steps of:
said advisory provider applying to be a member of the central provider;
said central provider performing due diligence and researching the professional information of the advisory provider; and
said central provider accepting the advisory provider as a member.

3. The method of claim 1 further comprising a step of:
said team of advisory providers formulating a wealth management plan for the client.

4. The method of claim 3 further comprising a step of:
said team of advisory providers implementing the wealth management plan for the client.

5. The method of claim 4 wherein:
said team of advisory providers selects at least one service/product provider to assist implementing the wealth management plan.

6. The method of claim 4 further comprising a step of:
said team of advisory providers monitoring the wealth management plan for the client.

7. The method of claim 1 wherein:
said central portal is a physical portal.

8. The method of claim 1 wherein:
said central portal is a virtual portal.

9. The method of claim 2 wherein step c further comprises:
matching the client's personal information with an advisory provider's professional information.

10. The method of claim 1 further comprising the step of:
providing the client's personal information to a vendor to be used as a sales lead.

11. A system of organizing a plurality of individual advisory providers from various professions into a team that provides services to a client through a central provider, said system comprising:
a client retaining a central provider to provide a team of advisory providers;
said client providing client's personal information to the central provider to be saved in a central database;
said central provider selecting a plurality of advisory providers from a group of member service providers to act as a team of advisory providers assigned to provide services to the client; and
said client receiving services from said team of service providers through a central portal provided by the central provider.

12. The system of claim 11 further comprising:
said advisory provider applying to be a member of the central provider;
said central provider performing due diligence and researching the professional information of the advisory provider; and
said central provider accepting the advisory provider as a member.

13. The system of claim 11 further comprising:
said team of advisory providers formulating a wealth management plan for the client.

14. The system of claim 13 further comprising:
said team of advisory providers implementing the wealth management plan for the client.

15. The system of claim 14 wherein:
said team of advisory providers selects at least one service/product provider to assist implementing the wealth management plan.

16. The system of claim 14 further comprising:
said team of advisory providers monitoring the wealth management plan for the client.

17. The system of claim 11 wherein:
said central portal is a physical portal.

18. The system of claim 11 wherein:
said central portal is a virtual portal.

19. The system of claim 21 further comprising:
matching the client's personal information with an advisory provider's professional information.

20. The system of claim 11 further comprising:
providing the client's personal information to a vendor to be used as a sales lead.
